(19) United States
(12) Patent Application Publication
(10) Pub. No.: US 2012/0040248 A1
(43) Pub. Date: Feb. 16, 2012

(54) POSITIVE ACTIVE MATERIAL AND NONAQUEOUS SECONDARY BATTERY EQUIPPED WITH POSITIVE ELECTRODE INCLUDING SAME

(75) Inventors: Takeshi Yao, Kyoto-shi (JP); Shogo Esaki, Osaka-shi (JP); Motoaki Nishijima, Osaka-shi (JP); Mitsuhiro Hibino, Kyoto-shi (JP); Kohei Hiroe, Kyoto-shi (JP)

(73) Assignee: Sharp Kabushiki Kaisha, Osaka (JP)

(21) Appl. No.: 13/265,437

(22) PCT Filed: Apr. 26, 2010
(86) PCT No.: PCT/JP2010/002992

§ 371 Date: Oct. 20, 2011

(30) Foreign Application Priority Data
Apr. 24, 2009 (JP) 2009-106754

(51) Int. Cl. H01M 4/505

(52) U.S. Cl. 429/224; 252/182.1; 252/519.15

(57) ABSTRACT

A positive active material according to the present invention used in a nonaqueous secondary battery, includes a lithium-containing transition metal oxide containing manganese, as a crystal structure of a main crystalline phase, and a sub oxide and tin (IV) oxide, each of which having an oxygen arrangement identical to that of the lithium-containing transition metal oxide however has a different element composition, the sub oxide and tin (IV) oxide being included in a state in which presence of the sub oxide and tin (IV) oxide is confirmable by diffractometry.

### TECHNICAL FIELD

The present invention relates to a positive active material for producing a long-lived nonaqueous electrolyte secondary battery. In particular, the present invention relates to a nonaqueous electrolyte secondary battery which is improved in storability and in its charge/discharge cycle life.

### BACKGROUND ART

Nonaqueous secondary batteries have often been used as a power source for portable devices, in view of their economical efficiency and like aspects. Various types of secondary batteries are available: currently, the most common type of the secondary batteries is a nickel-cadmium battery, and recently nickel-metal hydride batteries are also becoming more available. Meanwhile, a lithium secondary battery that uses lithium has been partially put to practical use due to their high output potential and their high energy density as compared to these secondary batteries. Moreover, studies on the lithium secondary battery have been eagerly conducted in recent years, to achieve an even higher performance. Currently, LiCoO₂ is available on the market as a positive material of the lithium secondary battery. However, due to the expensiveness of cobalt that is used as the raw material of LiCoO₂, LiMn₂O₄ using manganese, a cheaper raw material than cobalt, has been receiving attention.

However, with LiMn₂O₄, repetition of a charge/discharge cycle causes Mn contained in the positive active material to solve out as Mn ions, and Mn thus solved out is separated on a negative electrode as a metal Mn in the charging and discharging process. The metal Mn separated on the negative electrode reacts with lithium ions in an electrolytic solution, and as a result, causes a remarkable decrease in capacity as a secondary battery.

Various methods have been employed to improve these points. For instance, Patent Literature 1 introduces a method that covers particle surfaces of manganese oxides with a polymer to prevent manganese from solving out, and Patent Literature 2 introduces a method that covers the particle surfaces of manganese oxides with boron, to prevent manganese from solving out. Moreover, Patent Literature 3, Patent Literature 4, and Non Patent Literature 1 disclose a technique which, in order to prevent manganese from solving out, includes a substance having a different composition inside the LiMn₂O₄ crystal but having a similar configuration as the LiMn₂O₄ crystal in an electrode material.

### CITATION LIST

### Patent Literature

Patent Literature 1
Japanese Patent Application Publication, Tokukai, No. 2000-231919 A (Publication Date: Aug. 22, 2000)

Patent Literature 2
Japanese Patent Application Publication, Tokukaihei, No. 9-265984 A (Publication Date: Oct. 7, 1997)

Patent Literature 3
Japanese Patent Application Publication, Tokukai, No. 2001-176513 A (Publication Date: Jun. 29, 2001)

Patent Literature 4
Japanese Patent Application Publication, Tokukai, No. 2003-272631 A (Publication Date: Sep. 26, 2003)

### Non Patent Literature

Non Patent Literature 1
Mitsuhiro Hibino, Masayuki Nakamura, Yuji Kamitaka, Naoshi Ozawa and Takeshi Yao, Solid State Ionics Volume 177, Issues 26-32, 31 Oct. 2006, Pages 2653-2656.

### SUMMARY OF INVENTION

### Technical Problem

Although the conventional technique prevents the loss of Mn from the positive active material, the conventional configuration becomes the cause of other problems.

More specifically, each of the positive active material disclosed in Patent Literature 1 and Patent Literature 2 has the surface of LiMn₂O₄ be coated with a different insulating substance; this causes a remarkable increase in electric resistance from the LiMn₂O₄ particles. Hence, there is a drawback that output characteristics of the secondary battery are deteriorated.

Moreover, although the positive active material disclosed in Patent Literature 3, Patent Literature 4, and Non Patent Literature 1 have their high temperature characteristics improved by including, into the electrode material, a substance having a structure similar to the LiMn₂O₄ crystal to prevent manganese from solving out from LiMn₂O₄ upon charging or discharging the secondary battery, this does not solve the problem in cycle characteristics at room temperature.

The present invention is accomplished in view of the foregoing problem, and its object is to produce a long-lived positive active material in which solving out of Mn is prevented, while mixing no additives or the like into the electrolyte.

### Solution to Problem

In order to attain the object, a positive active material of the present invention includes: a lithium-containing transition metal oxide containing manganese, as a main crystalline phase; a sub oxide having an oxygen arrangement identical to the lithium-containing transition metal oxide but having a different element composition; and tin (IV) oxide, the sub oxide and tin (IV) oxide being included in the positive active material in such a manner that presence thereof is confirmable by diffractometry.

Since a sub oxide of the positive active material has an oxygen arrangement identical to that of the lithium-containing transition metal oxide, the sub oxide can be present in the lithium-containing transition metal oxide with good affinity. Moreover, tin (IV) oxide is also included; presence of these oxides is detectable and confirmable by diffractometry as described above. Namely, the inventors of the present invention found that by having crystal remain to the degree that the crystal can be detected by diffractometry, the second battery which uses the positive active material as its material can achieve further excellent cycle characteristics.

Examples of the diffractometry include X-ray diffractometry, neutron diffractometry, and electron diffractometry.

According to the configuration, it is possible to physically prevent expansion or shrinkage caused by elimination of lithium from or insertion of lithium into the lithium-containing transition metal oxide, by tin (IV) oxide and the sub oxide not involved in the charge and discharge and having high crystallinity.

This as a result allows for reducing deformation of crystal particles that construct the positive active material. Consequently, it is possible to reduce the decrease in capacity caused by cracking or the like of the crystal particles. Namely, the solving out of Mn is prevented without adding an additive or the like to an electrolytic solution, thereby making it possible to provide a long-lived positive active material.

Moreover, in the positive active material of the present invention, the sub oxide preferably contains a representative element and manganese.

By having the sub oxide contain a representative element and manganese, the sub oxide constructed via a common oxygen arrangement with the lithium-containing transition metal oxide is further stabilized. This further allows for preventing, with use of the sub oxide and tin (IV) oxide, the expansion or shrinkage of the lithium-containing transition metal oxide, which therefore makes it possible to further reduce the solving out of Mn.

Moreover, in the positive active material of the present invention, the sub oxide preferably contains zinc and manganese.

By having the sub oxide contain zinc and manganese, it is possible to remarkably stabilize the oxygen arrangement of the sub oxide. This further allows for preventing, with use of the sub oxide and tin (IV) oxide, the expansion or shrinkage of the lithium-containing transition metal oxide, which therefore makes it possible to further reduce the solving out of Mn.

Moreover, it is preferable that the positive active material according to the present invention is configured in such a manner that 0.01≦x≦0.20, where an overall composition including the main crystalline phase, the sub oxide, and tin (IV) oxide is represented by the following general formula A:

Li₁₋ₓM1₂₋₂ₓM2ₓM3₂ₓO_{4-y} (general formula A),

where M1 is manganese or manganese and an element of at least one type of a transition metal element, M2 and M3 are each independently at least one element selected from the group consisting of: transition metal elements, and representative elements of a metal, semiconductor or semimetal; and y is a value satisfying electrical neutrality with x. Moreover, it is preferable that y satisfies an inequality of 0≦y≦2.0, more preferably 0≦y≦1.0, and particularly preferably 0≦y≦0.5. Moreover, y is a value satisfying electrical neutrality with x, and can be the value of 0.

If the proportion of the sub oxide and tin (IV) oxide, i.e., x is in the foregoing range, it is possible to avoid the decrease in effect of the cycle characteristics without causing the decrease in discharge capacity, which decrease in effect is caused by the decrease in effect of preventing Mn from dispersing from the positive active material.

Moreover, in the positive active material of the present invention, the lithium-containing transition metal oxide contains just manganese as a transition metal.

This is advantageous in that the lithium-containing oxide can be easily synthesized. In the specification, a transition metal is an element that has a d orbital incompletely filled with electrons or an element that causes generationn of such a positive ion. On the other hand, a representative element denotes any other element. For example, a zinc atom Zn has an electron configuration of 1s²2s²2p⁶3s²3p⁶4s²3d¹⁰, whereas a positive ion of zinc, which is Zn²⁺, has an electron configuration of 1s²2s²2p⁶3s²3p⁶3d¹⁰. The atom and the positive ion both have 3d¹⁰, and thus neither of them has an “incompletely filled d orbital”. Zn is therefore a representative element.

Moreover, it is preferable that the positive active material of the present invention is configured in such a manner that a peak strength ratio B/A of a diffraction peak strength A of the main crystalline phase and a diffraction peak strength B of tin (IV) oxide satisfies the following inequality: 0<B/A<2.2, where the diffraction peak strength A is a value being observed when 2θ=18.2±0.5° and the diffraction peak strength B is a value being observed when 2θ=26.5±0.5°, each by powder X-ray diffractometry whose radiation source is CuKα radiation.

Moreover, it is preferable that the positive active material of the present invention is configured in such a manner that a peak strength ratio D/C (α=0.5) of a diffraction peak strength C of the main crystalline phase and a diffraction peak strength D of tin (IV) oxide satisfies the following inequality: 0<D/C (α=0.5)<2, where the diffraction peak strength C is a value being observed when 2θ=44.2±0.5° and the diffraction peak strength D is a value being observed when 2θ=26.5±0.5°, each by thin film X-ray diffractometry whose radiation source is CuKα radiation and with an angle of incidence to the positive active material of 0.5°. In the specification, the thin film X-ray diffractometry denotes an asymmetric diffractometry which performs measurement by 2θ scanning upon fixing an angle of incidence α to the positive active material at a low angle. The low angle in the asymmetric diffractometry is specifically in a range from 0.1 degrees to 5 degrees. Note that a denotes the angle of incidence in the thin film X-ray diffractometry.

Moreover, it is preferable that the positive active material of the present invention is configured in such a manner that a peak strength ratio D/C (α=5) of a diffraction peak strength C of the main crystalline phase and a diffraction peak strength D of tin (IV) oxide satisfies the following inequality: 0<D/C (α=5)<1, where the diffraction peak strength C is a value being observed when 2θ=44.2±0.5° and the diffraction peak strength D is a value being observed when 2θ=26.5±0.5°, each by thin film X-ray diffractometry whose radiation source is CuKα radiation and with an angle of incidence to the positive active material of 5°. Note that a denotes the angle of incidence in the thin film X-ray diffractometry.

Moreover, it is preferable that the positive active material of the present invention is configured in such a manner that (a) a peak strength ratio D/C (α=0.5) of a diffraction peak strength C of the main crystalline phase being observed when 2θ=44.2±0.5° and a diffraction peak strength D of tin (IV) oxide being observed when 2θ=26.5±0.5°, each by thin film X-ray diffractometry whose radiation source is CuKα radiation and with an angle of incidence to the positive active material of 0.5° and (b) a peak strength ratio D/C (α=5) of a diffraction peak strength C of the main crystalline phase being observed when 2θ=44.2±0.5° and a diffraction peak strength D of tin (IV) oxide being observed when 2θ=26.5±0.5°, each by thin film X-ray diffractometry whose radiation source is CuKα radiation and with an angle of incidence to the positive active material of 5°, satisfy the following inequality: D/C (α=0.5)>D/C (α=5). Note that a denotes the angle of incidence in the thin film X-ray diffractometry.

Moreover, it is preferable that the positive active material of the present invention is configured in such a manner that a peak strength ratio F/E (α=0.5) of a diffraction peak strength E of the main crystalline phase and a diffraction peak strength F of the sub oxide satisfies the following inequality: 0<F/E (α=0.5)<1.8, where the diffraction peak strength E is a value being observed when 2θ=44.2±0.5° and the diffraction peak strength F is a value being observed when 2θ=34.3±0.5°, each by thin film X-ray diffractometry whose radiation source is CuKα radiation and with an angle of incidence to the positive active material of 0.5°. Note that a denotes the angle of incidence in the thin film X-ray diffractometry.

Moreover, it is preferable that the positive active material of the present invention is configured in such a manner that a peak strength ratio F/E (α=5) of a diffraction peak strength E of the main crystalline phase and a diffraction peak strength F of the sub oxide satisfies the following inequality: 0<F/E (α=5)<1.5, where the diffraction peak strength E is a value being observed when 2θ=44.2±0.5° and the diffraction peak strength F is a value being observed when 2θ=34.3±0.5°, each by a thin film X-ray diffractometry whose radiation source is CuKα radiation and with an angle of incidence to the positive active material of 5°. Note that a denotes the angle of incidence in the thin film X-ray diffractometry.

Moreover, it is preferable that the positive active material of the present invention is configured in such a manner that (a) a peak strength ratio F/E (α=0.5) of a diffraction peak strength E of the main crystalline phase being observed when 2θ=44.2±0.5° and a diffraction peak strength F of the sub oxide being observed when 2θ=34.3±0.5°, each by thin film X-ray diffractometry whose radiation source is CuKα radiation and with an angle of incidence to the positive active material of 0.5°, and (b) a peak strength ratio F/E (α=5) of a diffraction peak strength E of the main crystalline phase being observed when 2θ=44.2±0.5° and a diffraction peak strength F of the sub oxide being observed when 2θ=34.3±0.5°, each by thin film X-ray diffractometry whose radiation source is CuKα radiation and with an angle of incidence to the positive active material of 5°, satisfy the following inequality: F/E (α=0.5)>F/E (α=5). Note that a denotes the angle of incidence in the thin film X-ray diffractometry.

Moreover, the positive active material of the present invention is configured in such a manner that a peak width at half height G of a diffraction peak of the main crystalline phase satisfies the following inequality: 0.3°<G<0.6°, where the peak width at half height G is observed when 2θ=44.2±0.5°, by powder X-ray diffractometry whose radiation source is CuKα radiation. Note that G is a value represented by 2θ.

Material is securely determined as the positive active material according to the present invention based on the fact that the diffraction peak observed by the X-ray diffractometry satisfies the foregoing relationship.

Moreover, it is preferable that the positive active material of the present invention is configured in such a manner that the sub oxide contains manganese and an element M other than manganese so as to have an element ratio Mn/M satisfy the following inequality: 2<Mn/M<4.

Moreover, it is preferable that the positive active material of the present invention is configured in such a manner that the sub oxide contains manganese and zinc so as to have an element ratio Mn/Zn satisfy the following inequality: 2<Mn/Zn<4.

With the element ratio of zinc and manganese in the foregoing range, it is possible to preferably reduce the solving out of Mn.

Moreover, it is preferable that the positive active material of the present invention is configured in such a manner that the main crystalline phase has a lattice constant of not less than 8.22 Å but not more than 8.24 Å.

With the lattice constant of the lithium-containing transition metal oxide being in the foregoing range, it is possible to bring about a preferable effect that it is easy to cause the sub oxide to have an oxygen arrangement identical to that of the lithium-containing transition metal oxide.

Moreover, a nonaqueous secondary battery of the present invention includes: a positive electrode; a negative electrode; and a nonaqueous ion conductor, the negative electrode including either (i) a substance containing lithium or (ii) a negative active material into which lithium can be inserted or from which lithium can be eliminated, and the positive electrode including the positive active material.

According to the invention, it is possible to reduce the solving out of Mn, which allows for providing a nonaqueous electrolyte secondary battery whose cycle characteristics are largely improved. Furthermore, it is possible to provide a nonaqueous electrolyte secondary battery whose discharge capacity is difficult to decrease.

### Advantageous Effects of Invention

As described above, the positive active material of the present invention includes a sub oxide having an oxygen arrangement identical to the lithium-containing transition metal oxide but having a different element composition; and tin (IV) oxide, the sub oxide and tin (IV) oxide being included in the positive active material in such a manner that presence thereof is confirmable by diffractometry.

This thus allows for decreasing the deformation of crystal particles which construct the positive active material, thereby reducing the decrease in capacity caused by cracking or the like of the crystal particles. Namely, an effect is brought about that a long-lived positive active material is provided, which is held down in solving out of Mn without adding any additives or the like into the electrolytic solution.

For a fuller understanding of the nature and advantages of the invention, reference should be made to the ensuing detailed description taken in conjunction with the accompanying drawings.

### BRIEF DESCRIPTION OF DRAWINGS

FIG. 1 is a graph showing an observation result of powder X-ray diffractometry.

FIG. 2 is a graph showing an observation result of thin film X-ray diffractometry.

FIG. 3 is a graph showing an observation result of thin film X-ray diffractometry.

### DESCRIPTION OF EMBODIMENTS

The following description further describes the present invention in detail. In the present specification, positive active material refers to positive active material for use in a nonaqueous electrolyte secondary battery, a positive electrode refers to a positive electrode for a nonaqueous electrolyte secondary battery, a secondary battery refers to a nonaqueous electrolyte secondary battery, and a lithium-containing oxide refers to a lithium-containing transition metal oxide, as appropriate.

<Positive Active Material>

The positive active material according to the present invention includes a main crystalline phase (hereinafter referred simply as main crystalline phase), and further includes a sub oxide and tin (IV) oxide. The main crystalline phase has a crystal structure constructed of a lithium-containing oxide (lithium-containing transition metal oxide) that contains manganese. The lithium-containing oxide generally has a spinel structure, however can be used as the lithium-containing oxide of the present invention even if the lithium-containing oxide does not have a spinel structure.

The lithium-containing oxide specifically has a composition including at least lithium, manganese, and oxygen. The lithium-containing oxide may also substantially include a transition metal other than manganese. The transition metal other than manganese is not particularly limited, provided that it does not obstruct a function of the positive active material. Specific examples of the transition metal encompass Ti, V, Cr, Fe, Cu, Ni, and Co. The lithium-containing oxide, however, preferably includes only manganese as the transition metal because the lithium-containing oxide can, in such a case, be synthesized easily.

The lithium-containing oxide generally has a spinel structure, and the lithium-containing oxide which has the spinel structure can be expressed as Li:M:O=1:2:4, where M is a transition metal including manganese.

As generally known, the lithium-containing oxide with the spinel structure, however, often varies from the composition ratio of Li:M:O=1:2:4, and the same applies for the positive active material of the present invention. The lithium-containing transition metal oxide which includes manganese serving as a main crystalline phase is not limited in composition ratio to 1:2:4, and a similar effect is brought about as long as the lithium-containing oxide includes Li, a transition metal, and oxygen, and has a spinel structure.

More specifically, examples thereof include LiM₂O₄ in which Li:M:O is 1:2:4, a non-stoichiometric compound such as LiM₂O_{3.5} to LiMn₂O_{4.5} whose ratio of Li:M is 2 but are different in oxygen amount, or Li₄M₅O₁₂.

Moreover, in the positive active material of the present invention, the main crystalline phase preferably has a lattice constant of not less than 8.22 Å and not greater than 8.24 Å. In a case where the lithium-containing transition metal oxide has a lattice constant which falls within the above range, a distance between and an arrangement of the lithium-containing transition metal oxide match a distance between and an arrangement of oxygen atoms of an oxygen arrangement on any plane of the sub oxide having an oxygen arrangement identical to the lithium-containing transition metal oxide. This allows the sub oxide to bond to the main crystalline phase with good affinity. As such, the sub oxide can stably be present on the grain boundary and interface of the main crystalline phase.

The positive active material according to the present embodiment includes a sub oxide. The sub oxide has an oxygen arrangement identical to the lithium-containing oxide but has a different elementary composition from the lithium-containing oxide. By having an oxygen arrangement identical to the lithium-containing oxide, the sub oxide can be present on the grain boundary and interface of the lithium-containing oxide with good affinity, which lithium-containing oxide is the main crystalline phase and which includes manganese. In the embodiment, to have an identical oxygen arrangement means that the sub crystalline phase and the lithium-containing oxide each have an oxygen arrangement based on a cubic closest packed structure. The oxygen arrangement does not necessarily have a perfect cubic closest packed structure: specifically, the oxygen arrangement can be distorted in any axis direction, or have an oxygen defective portion or regularly-occurring oxygen defects. The sub crystalline phase can have a crystal structure which is a cubic crystal, a tetragonal crystal, an orthorhombic crystal, a monoclinic crystal, a trigonal crystal, a hexagonal crystal, or a triclinic crystal. An example of a compound having a cubic crystal is MgAl₂O₄. An example of a compound having a tetragonal crystal is ZnMn₂O₄. An example of a compound having an orthorhombic crystal is CaMn₂O₄. The composition of the sub crystalline phase is not necessarily stoichiometric: the sub crystalline phase may include Mg or Zn partially substituted by another element such as Li, or Mg or Zn partially defected.

In a case where the sub oxide has the same oxygen arrangement as the oxygen arrangement of the lithium-containing oxide, the sub oxide can, via the same oxygen arrangement, bond to the main crystalline phase with good affinity. The sub oxide can thus be stably present in the main crystalline phase.

The sub oxide preferably contains a representative element and manganese, and further preferably contains zinc and manganese. This allows for further stabilizing the sub oxide which bonds to the lithium-containing transition metal oxide via a common oxygen arrangement. Consequently, it is possible to further prevent the expansion or shrinkage of the lithium-containing transition metal oxide, and further reduce the solving out of Mn.

In a case where the positive active material of the present invention includes a large mixed amount of the sub oxide and tin (IV) oxide, a relative amount of the lithium-containing oxide decreases in amount if the positive active material is used as positive material for material for the secondary battery. This may cause reduction of discharge capacity to the positive active material. Alternatively, if the mixed amount of the sub oxide and tin (IV) oxide is small, the effect of holding down the solving out of Mn from the main crystalline phase is reduced. This is not preferable, since the effect of improving the cycle characteristics of the secondary battery would decrease.

In consideration of these points, the mixed amount of the sub oxide and tin (IV) oxide to the positive active material is preferably made to be so that the range of x in the general formula A is 0.01≦x≦0.20, is further preferably 0.02≦x≦0.10, and is extremely preferably 0.03≦x≦0.07, in view of balance with the reduction of discharge capacity and the effect of improving the cycle characteristics.

In the embodiment, another spinel is a compound having a spinel-shaped configuration as with the lithium-containing oxide. The another spinel is required for synthesizing the main crystalline phase, the sub oxide and tin (IV) oxide, each of which are included in the positive active material according to the present invention.

Note that another spinel synthesized by a solid phase method may be mixed, or another spinel synthesized by a hydrothermal synthesis method or the like may be used.

Furthermore, the positive active material according to the present invention includes tin (IV) oxide. As such, tin (IV) oxide is to be included in the positive active material, and of course may be included in the sub oxide. There is no limitation to what material is served as raw material of tin (IV) oxide.

It is preferable to have a mixed amount of tin (IV) oxide in the positive active material to be specifically so that a range of x is 0.01≦x≦0.10 in the general formula A, since this amount can further prevent the solving out of Mn.

The positive active material according to the present embodiment includes the sub oxide and tin (IV) oxide in such a manner that presence thereof is confirmable by powder X-ray diffractometry whose radiation source is CuKα radiation. In other words, it can be said that the positive active material according to the present embodiment includes the sub oxide and tin (IV) oxide in a mixed amount which allows for confirming the presence of the sub oxide and tin (IV) oxide by the powder X-ray diffractometry whose radiation source is CuKα radiation. Namely, the sub oxide and tin (IV) oxide in the positive active material are detected by the powder X-ray diffractometry whose radiation source is CuKα radiation, by which the presence of the sub oxide and tin (IV) oxide can be confirmed.

As such, the inventors of the present invention found that by having crystals enough to be detected by the powder X-ray diffractometry remain therein, the cycle characteristics excels more when the positive active material is used as material for the secondary battery.

Hence, it is possible to physically prevent expansion or shrinkage caused by eliminating lithium from or inserting lithium into a lithium-containing transition metal oxide including manganese, by the sub oxide having high crystallinity and tin (IV) oxide, each of which is not involved in the charging and discharging.

As a result, it is possible to reduce the deformation of the crystal particles which construct the positive active material, thereby allowing for reducing the decrease in capacity caused by cracking or the like of the crystal particles. Namely, it is possible to prevent the solving out of Mn without adding any additives or the like to the electrolytic solution, whereby making it possible to provide a long-lived positive active material.

Moreover, it is preferable that the positive active material of the present invention is configured in such a manner that a peak strength ratio B/A of a diffraction peak strength A of the main crystalline phase and a diffraction peak strength B of tin (IV) oxide satisfies the following inequality: 0<B/A<2.2, where the diffraction peak strength A is a value being observed when 2θ=18.2±0.5° and the diffraction peak strength B is a value being observed when 2θ=26.5±0.5°, each by powder X-ray diffractometry whose radiation source is CuKα radiation.

Moreover, it is preferable that the positive active material of the present invention is configured in such a manner that a peak strength ratio D/C (α=0.5) of a diffraction peak strength C of the main crystalline phase and a diffraction peak strength D of tin (IV) oxide satisfies the following inequality: 0<D/C (α=0.5)<2, where the diffraction peak strength C is a value being observed when 2θ=44.2±0.5° and the diffraction peak strength D is a value being observed when 2θ=26.5±0.5°, each by thin film X-ray diffractometry whose radiation source is CuKα radiation and with an angle of incidence to the positive active material of 0.5°. Note that a denotes an angle of incidence in the thin film X-ray diffractometry.

Moreover, it is preferable that the positive active material of the present invention is configured in such a manner that a peak strength ratio D/C (α=5) of a diffraction peak strength C of the main crystalline phase and a diffraction peak strength D of tin (IV) oxide satisfies the following inequality: 0<D/C (α=5)<1, where the diffraction peak strength C is a value being observed when 2θ=44.2±0.5° and the diffraction peak strength D is a value being observed when 2θ=26.5±0.5°, each by thin film X-ray diffractometry whose radiation source is CuKα radiation and with an angle of incidence to the positive active material of 5°. Note that a denotes an angle of incidence in the thin film X-ray diffractometry.

Moreover, it is preferable that the positive active material of the present invention is configured in such a manner that (a) a peak strength ratio D/C (α=0.5) of a diffraction peak strength C of the main crystalline phase being observed when 2θ=44.2±0.5° and a diffraction peak strength D of tin (IV) oxide being observed when 2θ=26.5±0.5°, each by thin film X-ray diffractometry whose radiation source is CuKα radiation and with an angle of incidence to the positive active material of 0.5° and (b) a peak strength ratio D/C (α=5) of a diffraction peak strength C of the main crystalline phase being observed when 2θ=44.2±0.5° and a diffraction peak strength D of tin (IV) oxide being observed when 2θ=26.5±0.5°, each by thin film X-ray diffractometry whose radiation source is CuKα radiation and with an angle of incidence to the positive active material of 5°, satisfy the following inequality: D/C (α=0.5)>D/C (α=5). Note that a denotes the angle of incidence of the thin film X-ray diffractometry.

Moreover, it is preferable that the positive active material of the present invention is configured in such a manner that a peak strength ratio F/E (α=0.5) of a diffraction peak strength E of the main crystalline phase and a diffraction peak strength F of the sub oxide satisfies the following inequality: 0<F/E (α=0.5)<1.8, where the diffraction peak strength E is a value being observed when 2θ=44.2±0.5° and the diffraction peak strength F is a value being observed when 2θ=34.3±0.5°, each by thin film X-ray diffractometry whose radiation source is CuKα radiation and with an angle of incidence to the positive active material of 0.5°. Note that a denotes the angle of incidence of the thin film X-ray diffractometry.

Moreover, it is preferable that the positive active material of the present invention is configured in such a manner that a peak strength ratio F/E (α=5) of a diffraction peak strength E of the main crystalline phase and a diffraction peak strength F of the sub oxide satisfies the following inequality: 0<F/E (α=5)<1.5, where the diffraction peak strength E is a value being observed when 2θ=44.2±0.5° and the diffraction peak strength F is a value being observed when 2θ=34.3±0.5°, each by thin film X-ray diffractometry whose radiation source is CuKα radiation and with an angle of incidence to the positive active material of 5°. Note that a denotes an angle of incidence in the thin film X-ray diffractometry.

Moreover, it is preferable that the positive active material of the present invention is configured in such a manner that (a) a peak strength ratio F/E (α=0.5) of a diffraction peak strength E of the main crystalline phase being observed when 2θ=44.2±0.5° and a diffraction peak strength F of the sub oxide being observed when 2θ=34.3±0.5°, each by thin film X-ray diffractometry whose radiation source is CuKα radiation and with an angle of incidence to the positive active material of 0.5°, and (b) a peak strength ratio F/E (α=5) of a diffraction peak strength E of the main crystalline phase being observed when 2θ=44.2±0.5° and a diffraction peak strength F of the sub oxide being observed when 2θ=34.3±0.5°, each by thin film X-ray diffractometry whose radiation source is CuKα radiation and with an angle of incidence to the positive active material of 5°, satisfy the following inequality: F/E (α=0.5)>F/E (α=5). Note that a denotes an angle of incidence in the thin film X-ray diffractometry.

Moreover, it is preferable that the positive active material of the present invention is configured in such a manner that a peak width at half height G of a diffraction peak of the main crystalline phase satisfies the following inequality: 0.3°<G<0.6°, where the peak width at half height G is observed when 2θ=44.2±0.5°, by powder X-ray diffractometry whose radiation source is CuKα radiation. Note that G is a value denoted by 2θ.

Material is securely determined as the positive active material according to the present invention based on the fact that the diffraction peak observed by the X-ray diffractometry satisfies the foregoing relationship.

<Method for Producing Secondary Battery>

The following description deals with a method for producing a secondary battery. The description first deals with a method for preparing a raw material for the positive active material, that is, another spinel.

[Preparation of Another Spinel]

Preparation of the another spinel is not particularly limited in method. The method can be a publicly known method such as a solid phase method or a hydrothermal method. The method can alternatively be a sol-gel process or spray pyrolysis.

In a case where the another spinel is prepared by a solid phase method, the another spinel is made of a raw material which contains an element to be contained in the another spinel. The raw material can be an oxide or a chloride such as a carbonate, a nitrate, a sulfate, and a hydrochloride, each of which includes the above element.

Specific examples of the raw material include manganese dioxide, manganese carbonate, manganese nitrate, lithium oxide, lithium carbonate, lithium nitrate, magnesium oxide, magnesium carbonate, magnesium nitrate, calcium oxide, calcium carbonate, calcium nitrate, aluminum oxide, aluminum nitrate, zinc oxide, zinc carbonate, zinc nitrate, iron oxide, iron carbonate, iron nitrate, tin (IV) oxide, tin carbonate, tin nitrate, titanium oxide, titanium carbonate, titanium nitrate, vanadium pentoxide, vanadium carbonate, vanadium nitrate, cobalt oxide, cobalt carbonate, and cobalt nitrate.

The raw material can alternatively be a hydrolysate M(OH)ₓ of a metal alkoxide containing an element M to be contained in the another spinel (where M represents an element such as manganese, lithium, magnesium, aluminum, zinc, iron, tin, titanium, and vanadium, and x represents a valence of the element M). The raw material can further alternatively be a metal ion solution containing the element M. The metal ion solution is used as the above raw material in a state where it is mixed with a thickening agent or a chelating agent.

The thickening agent can be a publicly known thickening agent, and is not particularly limited. The thickening agent is, for example, ethylene glycol or carboxymethyl cellulose. The chelating agent can also be a publicly known chelating agent, and is not particularly limited. The chelating agent is, for example, ethylenediaminetetraacetic acid or ethylenediamine.

The another spinel can be prepared by mixing and baking the above raw material so that the element is contained in the raw material in such an amount that the another spinel will have an intended composition ratio. The baking is carried out at a temperature which is set depending on the kind of the raw material to be used. The baking temperature thus cannot be easily specified by a particular value. In general, however, the baking can be carried out at a temperature which is not lower than 400° C. and not higher than 1500° C. The baking can be carried out in an inert atmosphere or in an oxygen-containing atmosphere.

The another spinel can also be synthesized by a hydrothermal method, which (i) dissolves, in an alkaline aqueous solution in an airtight container, a substance such as an acetate and a chloride as the raw material containing the element to be contained in the another spinel and (ii) heats the resulting solution. In a case where the spinel-type compound is synthesized by a hydrothermal method, the resulting spinel-type compound can be (i) directly used in a process below of producing the positive active material or (ii) used in the process of producing the positive active material after the resulting spinel-type compound has been subjected to a treatment such as a heat treatment.

In a case where the another spinel prepared by the above method has an average particle size of greater than 100 μm, it is preferable to reduce the average particle size. The particle size can be reduced by, for example, (i) crushing the another spinel in a mortar, a planetary ball mill etc. or (ii) classifying the spinel-type compound according to the particle size with use of a mesh or the like so that the spinel-type compound with a small average particle diameter is used in a subsequent process.

[Production of Positive Active Material]

The another spinel is next synthesized in a single phase and is then either (1) mixed with (i) a lithium source material serving as a raw material for the lithium-containing oxide and (ii) a manganese source material and baked, or (2) mixed with a separately synthesized lithium-containing oxide and baked. This produces a positive active material. As described above, the positive active material of the present embodiment is produced by a method using the another spinel prepared in advance.

The following describes a case of the method (1) above. First, the another spinel is compounded with (i) a lithium source material corresponding to a desired lithium-containing oxide and (ii) a manganese source material.

Examples of the lithium source material include lithium carbonate, lithium hydroxide, and lithium nitrate. Examples of the manganese source material include manganese dioxide, manganese nitrate, manganese acetate, and manganese carbonate. It is preferable to use electrolytic manganese dioxide as the manganese source material.

The manganese source material can be used in combination with a transition metal raw material containing a transition metal other than manganese. Examples of the transition metal include Ti, V, Cr, Fe, Cu, Ni, and Co. Examples of the transition metal raw material include an oxide of the transition metal, and a chloride such as a carbonate and hydrochloride, of the transition metal.

The method, after selecting a lithium source material and a manganese source material (including a transition metal raw material) to be mixed with the another spinel, compounds the lithium source material and the manganese source material (including the transition metal raw material) with the spinel-type compound so that a desired ratio for the lithium-containing oxide is achieved by (i) a proportion of Li in the lithium source material and (ii) a proportion of the manganese source material (including the transition metal raw material). In a case where, for example, the desired lithium-containing oxide is LiM₂O₄ (where M represents manganese and a transition metal), the lithium source material and the manganese source material (including the transition metal raw material) are compounded with each other in their respective amounts so that a ratio of Li to M is 1:2.

The method, after compounding the another spinel, the lithium source material, and the manganese source material in their respective amounts, uniformly mixes them (mixing step). The above mixing can be carried out in a publicly known mixing device such as a mortar and a planetary ball mill.

The another spinel, the lithium source material, and the manganese source material can be mixed with one another in their respective total amounts in a single operation. Alternatively, the lithium source material and the manganese source material can each be added in separate small portions to the total amount of the another spinel for the mixing. The alternative case is preferable because it can (i) gradually reduce a concentration of the another spinel and consequently (ii) carry out the mixing more uniformly.

The mixed raw material is further baked, to produce the positive active material (baking process). In order to easily bake the mixed raw material, the mixed raw material is preferably compressed into a pellet shape, and thereafter is baked in the pellet shape. The baking temperature is set depending on the types of mixed raw material, however is typically baked in a temperature range of not less than 400° C. but not more than 1000° C. Moreover, a typical baking time is preferably not more than 12 hours.

The baking may be carried out under air atmosphere, or may be carried out under an atmosphere having increased oxygen content. Moreover, the baking process may be repeated several times. In this case, the baking for a first time (pre-baking) and the baking for second and subsequent times may be carried out at a same temperature or at different temperatures. Furthermore, in the case where the baking is repeated a plurality of times, a sample may be crushed and again be compressed into a pellet shape, while the plurality of baking processes are carried out.

A highly preferable method for producing a positive active material is to (i) synthesize Zn₂SnO₄ serving as a spinel compound in a single phase, and then (ii) mix a lithium source material with a manganese source material and bake the mixture. This greatly improves cycle characteristics of a secondary battery to be produced.

[Production of Positive Electrode]

The positive active material produced as above is processed into a positive electrode through the steps below. The positive electrode is produced from a combination agent obtained by mixing the positive active material, a conductive material, and a binding agent.

The conductive material can be a publicly known conductive material, and is not particularly limited to a specific one. Examples of the conductive material include (i) a carbon such as carbon black, acetylene black, and Ketjen Black, (ii) graphite (either natural graphite or artificial graphite) powder, (iii) metal powder, and (iv) metal fiber.

The binding agent can be a publicly known binding agent, and is not particularly limited to a specific one. Examples of the binding agent include (i) a fluorine polymer such as polytetrafluoroethylene and polyvinylidene fluoride, (ii) a polyolefin polymer such as polyethylene, polypropylene, and ethylene-propylene-diene terpolymer, and (iii) styrene-butadiene-rubber.

Appropriate mixing proportions of the conductive material and the binding agent vary depending on kinds of the conductive material and the binding agent to be mixed, and each cannot easily be specified by a particular value. In general, however, (i) the conductive material can be mixed in an amount which is not less than 1 part by weight and not greater than 50 parts by weight, and (ii) the binding agent can be mixed in an amount which is not less than 1 parts by weight and not greater than 30 parts by weight, both with respect to 100 parts by weight of the positive active material.

If the conductive material is mixed in a proportion which is less than 1 part by weight, the resulting positive electrode will be large in resistance, polarization etc., and will thus have a small discharge capacity. This makes it impossible to produce a practical secondary battery with use of the positive electrode obtained. On the other hand, if the conductive material is mixed in a proportion which is greater than 50 parts by weight, the resulting positive electrode will have a reduced mixing proportion of the positive active material, and will thus have a small discharge capacity.

If the binding agent is mixed in a proportion which is less than 1 part by weight, the binding agent may not express its binding effect. On the other hand, if the binding agent is mixed in a proportion which is greater than 30 parts by weight, the resulting positive electrode will, as in the case of the conductive material, have a reduced mixing proportion of the active material. Further, the positive electrode will be large in resistance, polarization etc. similarly to the above case, and will thus unpractically have a small discharge capacity.

The combination agent can further include a filler, a dispersing agent, an ion conductor, a pressure enhancing agent, and any of other various additives in addition to the conductive material and the binding agent. The filler is not particularly limited to a specific one, provided that it is a fibrous material that does not chemically change in a secondary battery to be produced. The filler is typically an olefin polymer such as polypropylene and polyethylene, or fiber made of, for example, glass. The filler is not particularly limited in its added amount, but is preferably added in an amount which is not less than 0 parts by weight and not greater than 30 parts by weight with respect to the combination agent.

There is no particular limit to a method for producing a positive electrode from the combination agent, which includes a mixture of the positive active material, the conductive material, the binding agent, the various additives and the like. Examples of the method include: a method which compresses the combination agent into a positive electrode in a shape of a pellet; and a method which (i) adds an appropriate solvent to the combination agent so as to form a paste, (ii) applies the paste onto a current collector, (iii) dries the paste, and (iv) further compresses the paste so as to form a positive electrode in a shape of a sheet.

The current collector carries out transfer of electrons to and from the positive active material in the positive electrode. Thus, the current collector is provided to the positive active material produced. The current collector can be a simple metal, an alloy, carbon etc. Examples of the current collector include a simple metal such as titanium and aluminum, an alloy such as stainless steel, and carbon. The current collector can alternatively be a substance, such as copper, aluminum, or stainless steel, which has a surface that is provided with a layer of carbon, titanium, or silver. The current collector can further alternatively be a substance, such as copper, aluminum, or stainless steel, which has an oxidized surface.

The current collector can have a shape of a foil, a film, a sheet, a net, or a punched-out shape. The current collector can have a structure such as a lath structure, a porous structure, a foam, and formed fibers. The current collector has a thickness which is not less than 1 μm and not greater than 1 mm. The thickness is, however, not particularly limited.

[Production of Negative Electrode]

The secondary battery of the present invention includes a negative electrode which includes a lithium-containing material or a negative active material into which lithium can be inserted or from which lithium can be eliminated. In other words, the negative electrode includes a lithium-containing material or a negative active material which can occlude or release lithium.

The negative active material can be a publicly known negative active material. Examples of the negative active material include (i) a lithium alloy such as metal lithium, lithium/aluminum alloy, lithium/tin alloy, lithium/lead alloy, and Wood's metal, (ii) a substance which can electrochemically dope and dedope lithium ions, such as a conducting polymer (for example, polyacetylene, polythiophene, and polyparaphenylene), pyrolysis carbon, pyrolysis carbon which has been subjected to gas-phase pyrolysis in the presence of a catalyst, carbon baked from pitch, coke, tar etc., and carbon baked from a polymer such as cellulose and phenol resin, (iii) graphite into which lithium ions can be intercalated and from which lithium ions can be deintercalated, such as natural graphite, artificial graphite, and expanded graphite, and (iv) an inorganic compound which can dope and dedope lithium ions, such as WO₂ and MoO₂. Any of the above substances can be used individually, or a complex of the above substances can be used instead.

In a case where the negative active material is, among the above substances, one of (i) pyrolysis carbon, (ii) pyrolysis carbon which has been subjected to gas-phase pyrolysis in the presence of a catalyst, (iii) carbon baked from pitch, coke, tar etc., (iv) carbon baked from a polymer, and (v) graphite such as natural graphite, artificial graphite, and expanded graphite, it is possible to produce a secondary battery which is preferable in terms of battery characteristics, especially safety. Graphite is preferably used to produce a high-voltage secondary battery, in particular.

In a case where the negative active material for the negative electrode is a conducting polymer, carbon, graphite, an inorganic compound or the like, a conductive material and a binding agent may be added to the negative active material.

The conductive material can be, for example, (i) a carbon such as carbon black, acetylene black, and Ketjen Black, (ii) graphite (either natural graphite or artificial graphite) powder, (iii) metal powder, or (iv) metal fiber. The conductive material is, however, not limited to these.

The binding agent can be, for example, (i) a fluorine polymer such as polytetrafluoroethylene and polyvinylidene fluoride, (ii) a polyolefin polymer such as polyethylene, polypropylene, and ethylene-propylene-diene terpolymer, or (iii) styrene-butadiene-rubber. The binding agent is, however, not limited to these.

[Method of Fabricating Ion Conductor and Secondary Battery]

The secondary battery of the present invention may use an ion conductor which is a publicly known ion conductor. Examples of the ion conductor include an organic electrolytic solution, a solid electrolyte (either an inorganic solid electrolyte or an organic solid electrolyte), and a molten salt. Preferable among these is the organic electrolytic solution.

The organic electrolytic solution includes an organic solvent and an electrolyte. The organic solvent is a typical, aprotic organic solvent. Examples of the organic solvent include (i) an ester such as propylene carbonate, ethylene carbonate, butylene carbonate, diethyl carbonate, dimethyl carbonate, methyl ethyl carbonate, and γ-butyrolactone, (ii) a substituted tetrahydrofuran such as tetrahydrofuran and 2-methyltetrahydrofuran, (iii) an ether such as dioxolane, diethyl ether, dimethoxyethane, diethoxyethane, and methoxyethoxyethane, (iv) dimethyl sulfoxide, (v) sulfolane, (vi) methyl sulfolane, (vii) acetonitrile, (viii) methyl formate, and (ix) methyl acetate. Any of the above organic solvents can be used individually, or a mixed solvent of two or more of the above organic solvents can be used instead.

Examples of the electrolyte include a lithium salt such as lithium perchlorate, lithium borofluoride, lithium phosphofluoride, lithium arsenate hexafluoride, lithium trifluoromethanesulfonate, lithium halide, and lithium aluminate chloride. Any of the above electrolytes can be used individually, or a mixture of two or more of the electrolytes can be used instead. The above organic electrolytic solution is prepared by selecting an appropriate electrolyte for the organic solvent and dissolving the electrolyte in the organic solvent. Neither of the organic solvent and the electrolyte for use in preparing the organic electrolytic solution is limited to the above.

The inorganic solid electrolyte as the above solid electrolyte can be, for example, a nitride, halide, or oxysalt of Li. Specific examples of the inorganic solid electrolyte include Li₃N, LiI, Li₃N—LiI—LiOH, LiSiO₄, LiSiO₄—LiI—LiOH, Li₃PO₄—Li₄SiO₄, a phosphorous sulfide compound, and Li₂SiS₃.

The organic solid electrolyte as the above solid electrolyte is, for example, (i) a substance which includes the electrolyte included in the organic electrolyte and a polymer that dissociates the electrolyte or (ii) a substance which includes a polymer having an ionizable group.

Examples of the polymer that dissociates the electrolyte include a polyethylene oxide derivative, a polymer including the polyethylene oxide derivative, a polypropylene oxide derivative, a polymer including the polypropylene oxide derivative, and a phosphoric ester polymer. Alternatively, the electrolyte may contain (i) a polymer matrix material including the aprotic polar solvent, (ii) a mixture of the polymer having an ionizable group and the aprotic electrolyte, or (iii) polyacrylonitrile. A further alternative, known method is to use a combination of the inorganic solid electrolyte and the organic solid electrolyte.

The secondary battery includes a separator for retaining the electrolyte. The separator is, for example, (i) an unwoven fabric made of electrically insulating synthetic resin fiber, glass fiber, natural fiber or the like, (ii) a woven fabric, (iii) a micropore structure material or (iv) a molded object of powder of, for example, alumina. Preferable among the above in terms of quality stability and the like are (i) an unwoven fabric made of a synthetic resin such as polyethylene and polypropylene and (ii) a micropore structure. In a case where the separator is an unwoven fabric made of a synthetic resin or a micropore structure, the separator may be, if the battery generates an unusual amount of heat, dissolved by the heat and thus serve an additional function as a block between the positive electrode and the negative electrode. It is thus preferable to use these unwoven fabric made of a synthetic resin or a micropore structure, in terms of safety. The separator has a thickness which is not particularly limited, provided that it is thick enough to (i) retain a necessary amount of the electrolytic solution and (ii) prevent a short circuit between the positive electrode and the negative electrode. The thickness is normally in the order of not less than 0.01 mm and not greater than 1 mm, and preferably in the order of not less than 0.02 mm and not greater than 0.05 mm.

The secondary battery can be in any shape such as a coin shape, a button shape, a sheet shape, a cylinder shape, and an angular shape. In a case where the secondary battery is in the shape of a coin or a button, the secondary battery is normally produced by (i) forming each of the positive electrode and the negative electrode in a pellet shape, (ii) placing the positive electrode and the negative electrode in a battery can which has a can structure with a lid, and (iii) caulking (fixing) the lid in a state in which insulating packing is sandwiched between the can and the lid.

In a case where the secondary battery is in a cylindrical or angular shape, the secondary battery is produced by (i) inserting the positive electrode and the negative electrode both in a sheet shape into a battery can, (ii) electrically connecting the secondary battery to the positive electrode and the negative electrode in the sheet shape, (iii) injecting the electrolytic solution into the battery can, and (iv) either sealing the battery can with a sealing plate via insulating packing or insulating the sealing plate from the battery can with a hermetic seal to seal the battery can. The sealing plate can be a safety valve including a safety device. The safety device is, for example, an overcurrent preventing device such as a fuse, a bimetal, and a PTC (positive temperature coefficient) device. Other than the provision of a safety valve, it is possible to, for example, open a crack in a gasket or in the sealing plate or open a cut in the battery can in order to prevent an increase in an internal pressure of the battery can. The safety device can alternatively be an external circuit operable to prevent overcharge and over discharge.

The positive electrode and the negative electrode, in a case where they are both in a pellet shape or a sheet shape, are preferably dried or dehydrated in advance. The positive electrode and the negative electrode can be dried or dehydrated by a general method. The method is, for example, to use (i) solely any one of or (ii) any combination of hot air, vacuum, infrared radiation, far infrared radiation, electron rays, low-moisture air and the like. The positive electrode and the negative electrode are preferably dried or dehydrated at a temperature which is not less than 50° C. and not greater than 380° C.

The electrolytic solution is injected into the battery can by, for example, a method of applying an injection pressure to the electrolytic solution or a method that utilizes a difference between a negative pressure and an atmospheric pressure. The method is, however, not limited to these. Further, the electrolytic solution is injected by an amount that is not particularly limited. The amount is, however, preferably an amount which allows the positive electrode, the negative electrode, and the separator to be entirely immersed in the electrolytic solution.

The secondary battery thus produced is charged and discharged by a constant-current charge/discharge method, a constant-voltage charge/discharge method, or a constant-power charge/discharge method. The method is preferably selected according to a purpose of evaluating the battery. The secondary battery can be charged and discharged solely by any one of the above methods or by a combination of any of the above methods.

Since the positive electrode of the secondary battery of the present invention includes the above positive active material, it is possible to reduce the solving out of Mn. Consequently, it is possible to provide a nonaqueous secondary battery having greatly improved cycle characteristics. Further, it is possible to provide a nonaqueous secondary battery which is less likely to have a reduced discharge capacity.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### EXAMPLES

The following description deals in further detail of the present invention, with reference to Examples. The present invention is, however, not limited to the description of Examples. Measurements described below were obtained for bipolar cells (secondary batteries) and positive active materials produced in Examples and Comparative Examples below.

<Charge/Discharge Cycle Test>

Charge/discharge cycle tests were carried out to the obtained bipolar cells under conditions of: a current density of 0.5 mA/cm², a voltage in a range from 4.3 V to 3.2 V, and at temperatures of 25° C. and 60° C. An average value of discharge capacities calculated based on those taken from after the cycle was repeated five times until after the cycle was repeated ten times, served as an (initial discharge capacity), and a discharge capacity maintenance rate obtained by the charge/discharge cycle test was evaluated by use of an average value of discharge capacities (discharge capacity after 100 cycles) calculated based on those taken from after 98 cycles were carried out to after 102 cycles were carried out or an average value of discharge capacities (discharge capacity after 200 cycles) calculated based on those taken after 198 cycles were carried out to after 202 cycles were carried out. The discharge capacity maintenance rate was calculated by calculating: {(discharge capacity after 100 cycles)/(initial discharge capacity)}×100, or {(discharge capacity after 200 cycles)/(initial discharge capacity)}×100.

<X-ray Diffractometry of Powder of Positive Active Material>

X-ray diffractometry was performed to the obtained powder positive active material in the following three patterns as described in (1) to (3) below. This confirmed the presence of the sub oxide and tin (IV) oxide in the positive active material.

(1) X-ray Diffractometry 1

The powder of the positive active material was put on a powder X-ray diffractometer (RINT-2000, manufactured by Rigaku Corporation) whose radiation source was CuKa radiation, to obtain (i) a diffraction peak strength Ak of a main crystalline phase observed when 2θ=18.2±0.5° and (ii) a diffraction peak strength B of tin (IV) oxide observed when 20=26.5±0.5°. Thereafter, a peak strength ratio B/A was calculated from the (i) and (ii).

(2) X-ray Diffractometry 2

The powder of the positive active material was put on a thin film X-ray diffractometer (RINT-2500, and thin film rotatable sample stage: Cat No 2701V2, each manufactured by Rigaku Corporation) whose radiation source was CuKa radiation, to obtain, by thin film X-ray diffractometry having an angle of incidence of 0.5°, (i) a diffraction peak strength C of a main crystalline phase observed when 2θ=44.2±0.5° and (ii) a diffraction peak strength D of a tin (IV) oxide observed when 2θ=26.5±0.5°. Thereafter, a peak strength ratio D/C (α=0.5) was calculated from the (i) and (ii). Furthermore, by thin film X-ray diffractometry having an angle of incidence of 5°, (iii) a diffraction peak strength C of a main crystalline phase observed when 2θ=44.2±0.5° and (iv) a diffraction peak strength D of a tin (IV) oxide observed when 2θ=26.5±0.5° were observed, to calculate a peak strength ratio D/C (α=5) from the (iii) and (iv).

(3) X-ray Diffractometry 3

The powder of the positive active material was put on a thin film X-ray diffractometer (RINT-2500, and thin film rotatable sample stage Cat No 2701V2, each manufactured by Rigaku Corporation) whose radiation source was CuKα radiation, to obtain, by thin film X-ray diffractometry having an angle of incidence 0.5°, (i) a diffraction peak strength E of a main crystalline phase observed when 2θ=44.2±0.5° and (ii) a diffraction peak strength F of a sub oxide observed when 20=34.3±0.5°. Thereafter, a peak strength ratio F/E (α=0.5) was calculated from the (i) and (ii). Furthermore, by thin film X-ray diffractometry whose radiation source was CuKα radiation and which has an angle of incidence of 5° to the positive active substance, (iii) a diffraction peak strength E of a main crystalline phase observed when 2θ=44.2±0.5° and (iv) a diffraction peak strength F of a sub oxide observed when 2θ=34.3±0.5° were observed, to calculate a peak strength ratio F/E (α=5) from the (iii) and (iv).

### Example 1

The present example used (i) zinc oxide as a zinc source material and (ii) tin (IV) oxide as a tin source material. These materials were weighed so that the zinc and the tin would have a molar ratio of 2:1. The materials were then mixed for 5 hours in an automated mortar. The mixture was next baked at 1000° C. for 12 hours in an air atmosphere, so that a baked product was obtained. After the baking, the baked product thus obtained was crushed and mixed in an automated mortar for 5 hours, so that an another spinel was produced.

The present example further used (i) lithium carbonate as a lithium source material and (ii) electrolytic manganese dioxide as a manganese source material. These materials were weighed so that the lithium and the manganese would have a molar ratio of 1:2. Further, the another spinel was weighed so that the sub oxide and the main crystalline phase would achieve x=0.05 in general formula A. The lithium carbonate, the electrolytic manganese dioxide, and the another spinel were mixed with one another in an automated mortar for 5 hours, and then pre-baked at 550° C. for 12 hours in an air atmosphere. Next, a resulting baked product was crushed and mixed in an automated mortar for 5 hours, so that powder was obtained. The powder was molded into a pellet shape and then baked at 800° C. for 12 hours in an air atmosphere. A resulting baked product was next crushed and mixed in an automated mortar for 5 hours, so that a positive active material was obtained.

The positive active material at 80 parts by weight was mixed with (i) 15 parts by weight of acetylene black as the conductive material and (ii) 5 parts by weight of polyvinylidene fluoride as the binding agent. The mixture was then further mixed with N-methylpyrrolidone so as to be in a paste form. The paste was applied onto a 20-μm-thick aluminum foil so as to have a thickness of not less than 50 μm and not greater than 100 μm. The applied paste was dried and then punched out in a disk shape, having a diameter of 15.958 mm. The disk was then vacuum-dried, so that a positive electrode was produced.

The present example produced a negative electrode by punching a metal lithium foil having a predetermined thickness, so that a disk-shaped negative electrode having a diameter of 16.156 mm was obtained. The present example prepared a nonaqueous electrolytic solution as the nonaqueous electrolyte by (i) mixing ethylene carbonate with dimethyl carbonate at a volume ratio of 2:1 into a solvent, and (ii) dissolving LiPF₆ as a solute at 1.0 mol/l in the solvent. The present example used as the separator a porous polyethylene film having a thickness of 25 μm and a porosity of 40%.

The bipolar cell was produced using the foregoing positive electrode, negative electrode, nonaqueous electrolytic solution, and separator. Thereafter, the charge/discharge cycle test was carried out to the obtained bipolar cell. A result measured, at 25° C., of the initial discharge capacity and the content maintenance rate attained after the cycle test was carried out is as shown in Table 1, and the measured result at 60° C. thereof is as shown in Table 2.

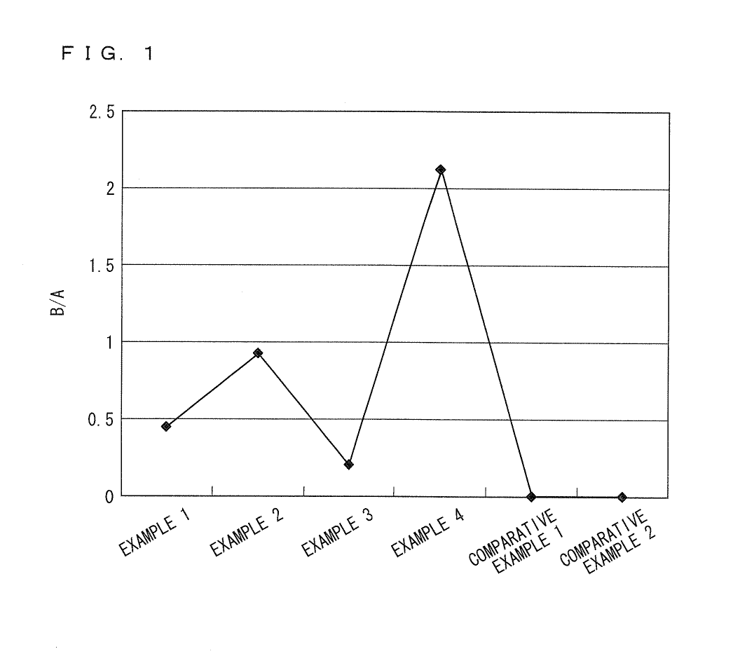

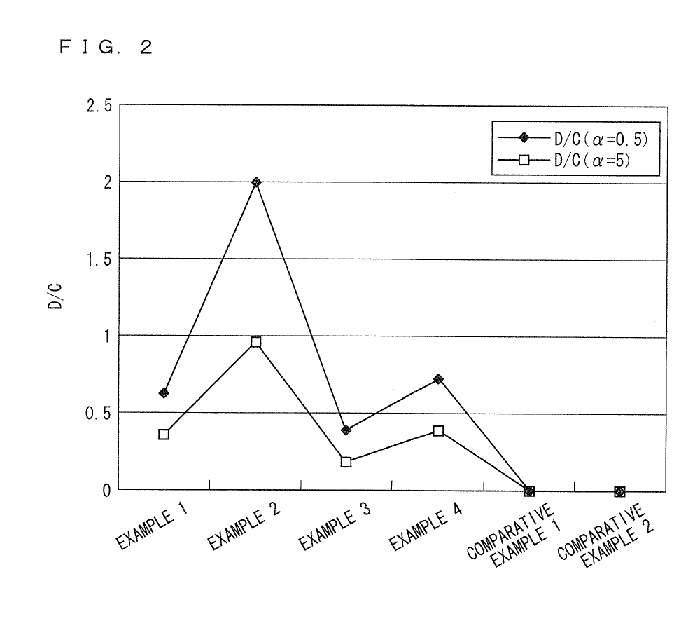

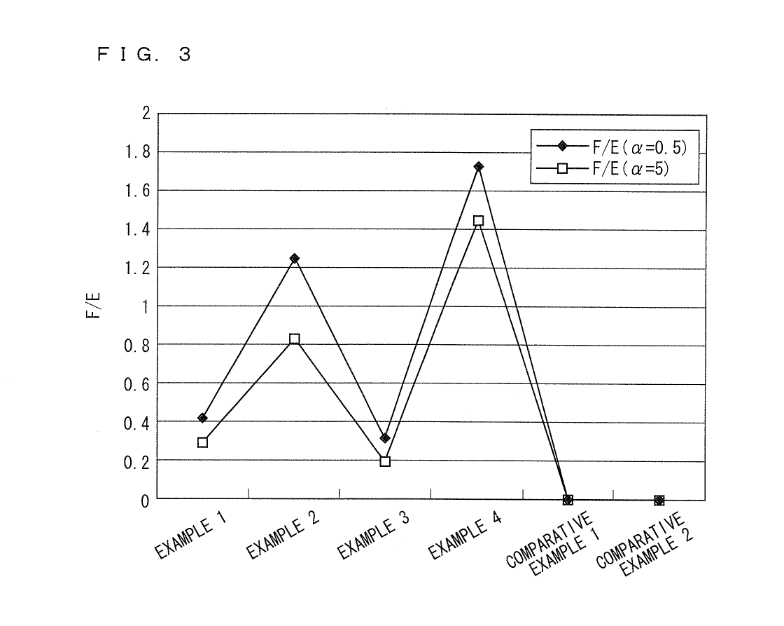

Moreover, the X-ray diffractometry 1 to 3 were performed to the obtained positive active material. FIG. 1 shows the peak strength ratio B/A obtained by the X-ray diffractometry 1 calculated with the diffraction peak strength B of tin (IV) oxide. Moreover, FIG. 2 shows the peak strength ratio D/C (α=5) obtained by the thin film X-ray diffractometry calculated with the diffraction peak strength D of tin (IV) oxide. FIG. 3 shows the peak strength ratio F/E (α=5) obtained by the powder X-ray diffractometry 2 with the diffraction peak strength F of the composition having a different composition including a combination of different elements from the main crystalline phase.

To a powder X-ray diffraction pattern of the positive active material obtained by the X-ray diffractometry, structure analysis was carried out by use of “RIETAN-2000” (F. Izuml AND T. Ikeda, Mater. Sci. Forum, 321-324 (2000) 198-203), by Rietveld analysis which used parameters shown in Tables 3 to 5 as initial values, in a three-phase mixed model of the main crystalline phase, the sub oxide and tin (IV) oxide.

With use of occupancies of each of 4a site (Zn site) and 8d site (Mn site) of the sub oxide obtained by the structure analysis result, an element ratio Mn/Zn of manganese and zinc included in the sub oxide was calculated. A result thereof is as shown in Table 6. The value of Mn/Zn was calculated by the following formula B:

[Mn/Zn]={8×[8d site occupancy]}/{4×[4a site occupancy]} (Formula B)

### Example 2

A synthesis similar to Example 1 was carried out, except that a composition amount of the starting material was changed so that the sub oxide and the main crystalline phase were made to satisfy x=0.10 in the general formula A. A bipolar cell was prepared in a similar method as Example 1, and a charge/discharge cycle test was carried out. Results thereof are as shown in Table 1 and Table 2. Moreover, results obtained by use of the powder X-ray diffractometer and the thin film X-ray diffractometry by a similar method as Example 1 are as shown in FIG. 1, FIG. 2, and FIG. 3.

Structure analysis by Rietveld analysis was carried out similarly to Example 1, and results of the structure analysis and an obtained value of Mn/Zn are as shown in Table 6.

### Example 3

A synthesis similar to Example 1 was carried out, except that a composition amount of the starting material was changed so that the sub oxide and the main crystalline phase were made to satisfy x=0.02 in the general formula A. A bipolar cell was prepared by a similar method as Example 1, and a charge/discharge cycle test was carried out. Results thereof are as shown in Table 1 and Table 2. Moreover, results obtained by use of the powder X-ray diffractometer and the thin film X-ray diffractometry in a similar method as Example 1 are as shown in FIG. 1, FIG. 2, and FIG. 3.

Structure analysis by Rietveld analysis was carried out similarly to Example 1, and results of the structure analysis and an obtained value of Mn/Zn are as shown in Table 6.

### Example 4

Synthesis similar to Example 1 was carried out, except that a composition amount of the starting material was changed so that the sub oxide and the main crystalline phase were made to satisfy x=0.20 in the general formula A. A bipolar cell was prepared by a similar method as Example 1, and a charge/discharge cycle test was carried out. Results thereof are as shown in Table 1 and Table 2. Moreover, results obtained by use of the powder X-ray diffractometer and the thin film X-ray diffractometry in a similar method as Example 1 are as shown in FIG. 1, FIG. 2, and FIG. 3.

Structure analysis by Rietveld analysis was carried out similarly to Example 1, and results of the structure analysis and an obtained value of Mn/Zn are as shown in Table 6.

### Comparative Example 1

A synthesis similar to Example 1 was carried out, except that (a) lithium carbonate was used as the lithium source material, (b) electrolyte manganese dioxide was used as the manganese source material, (c) none of the another spinel was mixed, and (d) the composition amount of these materials in the starting material was changed so that the molar ratio of lithium to manganese was 1:2. A bipolar cell was prepared by a method similar to Example 1, and the charge/discharge cycle test was carried out. Results thereof are as shown in Table 1 and Table 2. Moreover, a result obtained with the powder X-ray diffractometer and thin film X-ray diffractometry by a similar method to Example 1 is as shown in FIG. 1, FIG. 2, and FIG. 3.

Since baking was carried out without mixing the another spinel in Comparative Example 1, no peak of the sub oxide and tin (IV) oxide was detected. Hence, it was not possible to calculate the occupancy of the sub oxide and also the Mn/Zn.

### Comparative Example 2

After the starting material prepared in Comparative Example 1 and the another spinel were weighed to have a molar ratio of 95:5, synthesis was carried out thereto by mixing the starting material and the another spinel with an automated mortar for 5 hours. A bipolar cell was prepared by a method similar to Example 1, and the charge/discharge cycle test was carried out. Results thereof are as shown in Table 1 and Table 2. Moreover, a result obtained by a powder X-ray diffractometer and thin film X-ray diffractometry by a similar method to Example 1 is as shown in FIG. 1, FIG. 2, and FIG. 3.

In Comparative Example 2, the starting material and the another spinel were not baked, so no tin oxide was generated. Hence, no peak of the tin oxide was detected in FIGS. 1 to 3. Consequently, the occupancy of the sub oxide nor the Mn/Zn could be calculated.

TABLE 1
(Result of Charge/Discharge Cycle Test after 200 Cycles at 25° C.)

| | Capacity Maintenance Rate (%) |
|---|---|
| Example 1 | 90 |
| Example 2 | 91 |
| Example 3 | 87 |
| Example 4 | 96 |
| C. Example 1 | 80 |
| C. Example 2 | 80 |

Note:
C. Example denotes “Comparative Example”

TABLE 2
(Result of Charge/Discharge Cycle Test after 100 Cycles at 60° C.)

| | | Capacity Maintenance |
|---|---|---|
| | Initial Capacity (mAh/g) | Rate (%) |
| Example 1 | 91 | 73 |
| Example 2 | 76 | 84 |
| Example 3 | 90 | 65 |
| Example 4 | 65 | 87 |
| C. Example 1 | 120 | 43 |
| C. Example 2 | 114 | 43 |

Note:
C. Example denotes “Comparative Example”

TABLE 3
Parameters of Initial Values of Main Crystalline Phase
Space Group Fd-3m

| | a | b | c |
|---|---|---|---|
| Lattice | 8.2327 | 8.2327 | 8.2327 |
| Constant | | | |

| Element | Site name | Occupancy | x | y | z |
|---|---|---|---|---|---|
| Li | 8a | 1.0 | 0.0000 | 0.0000 | 0.0000 |
| Mn | 16d | 1.0 | 0.6250 | 0.6250 | 0.6250 |
| O | 32e | 1.0 | 0.3833 | 0.3833 | 0.3833 |

TABLE 4
Parameters of Initial Values of Sub Oxide
Space Group I 41/a m d

| | a | b | c |
|---|---|---|---|
| Lattice | 5.7172 | 5.7172 | 9.2387 |
| Constant | | | |

| Element | Site name | Occupancy | x | y | z |
|---|---|---|---|---|---|
| Zn | 4a | 1.0 | 0.0000 | 0.7500 | 0.1250 |
| Mn | 8d | 1.0 | 0.0000 | 0.5000 | 0.5000 |
| O | 16h | 1.0 | 0.0000 | 0.0250 | 0.5000 |

TABLE 5
Parameters of Initial Values of Tin (IV) Oxide
Space Group P 42/m n m

| | a | b | c |
|---|---|---|---|
| Lattice | 4.7380 | 4.7380 | 3.1865 |
| Constant | | | |

| Element | Site name | Occupancy | x | y | z |
|---|---|---|---|---|---|
| Sn | 2a | 1.0 | 0.0000 | 0.0000 | 0.0000 |
| O | 4g | 1.0 | 0.3071 | 0.3071 | 0.5000 |

TABLE 6
Structure Analysis Result and Element Ratio Mn/Zn
of Manganese and Zinc included in Sub Oxide

| | Zn Occupancy (4a) | Mn Occupancy (8d) | Mn/Zn |
|---|---|---|---|
| Example 1 | 0.870 | 0.991 | 2.28 |
| Example 2 | 0.903 | 0.989 | 2.19 |
| Example 3 | 0.499 | 0.988 | 3.96 |
| Example 4 | 0.975 | 0.980 | 2.01 |
| C. Example 1 | — | — | — |
| C. Example 2 | — | — | — |

Note:
C. Example denotes “Comparative Example”

It can be observed from FIG. 1 to FIG. 3 that in Examples 1 to 4, peaks of the sub oxide and tin (IV) oxide were detected by powder X-ray diffractometry whose radiation source is CuKα radiation, which allows for confirming the presence of the sub oxide and tin (IV) oxide.

Moreover, as seen in Table 1 and Table 2, although initial capacities compares unfavorably with Comparative Examples 1 and 2, the present Examples 1 to 4 clearly have a high capacity maintenance rate, particularly at 60° C. Therefore, in the bipolar cell according to the present Example, a good balance is yielded of the initial capacity with the capacity maintenance rate, thereby achieving a long life.

As described above, it was found that in a positive active material including, as a crystal structure of a main crystalline phase, a lithium-containing oxide which contains manganese, a capacity maintenance rate (cycle characteristics) at a high temperature of the bipolar cell is improved by including the sub oxide and tin (IV) oxide.

The cycle characteristics are considered to be largely improved by the following theory. By having sub oxide and tin (IV) oxide be present in the main crystalline phase of the lithium-containing oxide which contains manganese, dispersion of Mn from inside the crystal is physically blocked by the crystalline phase of the sub oxide. This holds down the solving out of Mn, which as a result largely improves the cycle characteristics. Furthermore, by having a sub oxide with high crystallinity which is not involved in the charging and discharging reaction and tin (IV) oxide be present in a crystalline phase of a lithium-containing oxide which includes manganese as its main crystalline phase, it is possible to physically prevent expansion and shrinkage caused by eliminating lithium from and inserting lithium into the lithium-containing oxide that contains manganese. This enables reduction of deformation of the crystal particles constructing the positive active material. As a result, it is possible to reduce the decrease in capacity caused by cracking and the like of the crystal particles.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to a nonaqueous secondary battery for use in, for example, a portable information terminal, a portable electronic device, a small-size household power storage device, a motor-powered electric bicycle, an electric vehicle, and a hybrid electric vehicle.

1. A positive active material for use in a nonaqueous secondary battery, the positive active material comprising:
a lithium-containing transition metal oxide containing manganese, as a crystal structure of a main crystalline phase;
a sub oxide having an oxygen arrangement identical to the lithium-containing transition metal oxide but having a different element composition; and
tin (IV) oxide,
the sub oxide and tin (IV) oxide being included in the positive active material in such a manner that presence thereof is confirmable by diffractometry.

2. The positive active material according to claim 1, wherein the sub oxide contains a representative element and manganese.

3. The positive active material according to claim 2, wherein the sub oxide contains zinc and manganese.

4. The positive active material according to claim 1, wherein
0.01≦x≦0.20
where an overall composition including the main crystalline phase, the sub oxide, and tin (IV) oxide is represented by the following general formula A:
Li₁₋ₓM1₂₋₂ₓM3₂ₓO_{4-y} (general formula A)
where M1 is manganese or manganese and an element of at least one type of a transition metal element, M2 and M3 are each independently at least one element selected from the group consisting of: transition metal elements, and representative elements of a metal, semiconductor or semimetal; and y is a value satisfying electrical neutrality with x.

5. The positive active material according to claim 1, wherein the lithium-containing transition metal oxide contains just manganese as a transition element.

6. The positive active material according to claim 1, wherein a peak strength ratio B/A of a diffraction peak strength A of the main crystalline phase and a diffraction peak strength B of tin (IV) oxide satisfies the following inequality:
0<B/A<2.2,
where the diffraction peak strength A is a value being observed when 2θ=18.2±0.5° and the diffraction peak strength B is a value being observed when 2θ=26.5±0.5°, each by powder X-ray diffractometry whose radiation source is CuKα radiation.

7. The positive active material according to claim 1, wherein a peak strength ratio D/C (α=0.5) of a diffraction peak strength C of the main crystalline phase and a diffraction peak strength D of tin (IV) oxide satisfies the following inequality:
0<D/C(α=0.5)<2,
where the diffraction peak strength C is a value being observed when 2θ=44.2±0.5° and the diffraction peak strength D is a value being observed when 2θ=26.5±0.5°, each by thin film X-ray diffractometry whose radiation source is CuKα radiation and with an angle of incidence to the positive active material of 0.5°, and a is an angle of incidence in the thin film X-ray diffractometry.

8. The positive active material according to claim 1, wherein a peak strength ratio D/C (α=5) of a diffraction peak strength C of the main crystalline phase and a diffraction peak strength D of tin (IV) oxide satisfies the following inequality:
0<D/C(α=5)<1,
where the diffraction peak strength C is a value being observed when 2θ=44.2±0.5° and the diffraction peak strength D is a value being observed when 2θ=26.5±0.5°, each by thin film X-ray diffractometry whose radiation source is CuKα radiation and with an angle of incidence to the positive active material of 5°, and a is an angle of incidence in the thin film X-ray diffractometry.

9. The positive active material according to claim 1, wherein (a) a peak strength ratio D/C (α=0.5) of a diffraction peak strength C of the main crystalline phase being observed when 2θ=44.2±0.5° and a diffraction peak strength D of tin (IV) oxide being observed when 2θ=26.5±0.5°, each by thin film X-ray diffractometry whose radiation source is CuKα radiation and with an angle of incidence to the positive active material of 0.5° and (b) a peak strength ratio D/C (α=5) of a diffraction peak strength C of the main crystalline phase being observed when 2θ=44.2±0.5° and a diffraction peak strength D of tin (IV) oxide being observed when 28=26.5±0.5°, each by thin film X-ray diffractometry whose radiation source is CuKα radiation and with an angle of incidence to the positive active material of 5°, satisfy the following inequality:
D/C(α=0.5)>D/C(α=5),
where α is an angle of incidence of the thin film X-ray diffractometry.

10. The positive active material according to claim 1, wherein a peak strength ratio F/E (α=0.5) of a diffraction peak strength E of the main crystalline phase and a diffraction peak strength F of the sub oxide satisfies the following inequality:
0<F/E (α=0.5)<1.8,
where the diffraction peak strength E is a value being observed when 2θ=44.2±0.5° and the diffraction peak strength F is a value being observed when 2θ=34.3±0.5°, each by thin film X-ray diffractometry whose radiation source is CuKα radiation and with an angle of incidence to the positive active material of 0.5°, and a is an angle of incidence of the thin film X-ray diffractometry.

11. The positive active material according to claim 1, wherein a peak strength ratio F/E (α=5) of a diffraction peak strength E of the main crystalline phase and a diffraction peak strength F of the sub oxide satisfies the following inequality:
0<F/E(α=5)<1.5,
where the diffraction peak strength E is a value being observed when 2θ=44.2±0.5° and the diffraction peak strength F is a value being observed when 2θ=34.3±0.5°, each by a thin film X-ray diffractometry whose radiation source is CuKα radiation and with an angle of incidence to the positive active material of 5°, and, α is an angle of incidence in the thin film X-ray diffractometry.

12. The positive active material according to claim 1, wherein (a) a peak strength ratio F/E (α=0.5) of a diffraction peak strength E of the main crystalline phase being observed when 2θ=44.2±0.5° and a diffraction peak strength F of the sub oxide being observed when 2θ=34.3±0.5°, each by thin film X-ray diffractometry whose radiation source is CuKα radiation and with an angle of incidence to the positive active material of 0.5°, and (b) a peak strength ratio F/E (α=5) of a diffraction peak strength E of the main crystalline phase being observed when 2θ=44.2±0.5° and a diffraction peak strength F of the sub oxide being observed when 2θ=34.3±0.5°, each by thin film X-ray diffractometry whose radiation source is CuKα radiation and with an angle of incidence to the positive active material of 5°, satisfy the following inequality:
F/E(α=0.5)>F/E(α=5),
where α is an angle of incidence in the thin film X-ray diffractometry.

13. The positive active material according to claim 1, wherein a peak width at half height G of a diffraction peak of the main crystalline phase satisfies the following inequality:
0.3°<G<0.6°,
where the peak width at half height G is observed when 2θ=44.2±0.5°, by powder X-ray diffractometry whose radiation source is CuKα radiation, and G is a value represented by 2θ.

14. The positive active material according to claim 1, wherein the sub oxide contains manganese and an element M other than manganese so as to have an element ratio Mn/M satisfying the following inequality:
2<Mn/M<4.

15. The positive active material according to claim 1, wherein the sub oxide contains manganese and zinc so as to have an element ratio Mn/Zn satisfying the following inequality:
2<Mn/Zn<4.

16. The positive active material according to claim 1, wherein the main crystalline phase has a lattice constant of not less than 8.22 Å but not more than 8.24 Å.

17. A nonaqueous secondary battery, comprising:
a positive electrode;
a negative electrode; and
a nonaqueous ion conductor,
the negative electrode including either (i) a substance containing lithium or (ii) a negative active material into which lithium can be inserted or from which lithium can be eliminated, and
the positive electrode including the positive active material according to claim 1.
